(19) United States
(12) Patent Application Publication
(10) Pub. No.: US 2008/0282289 A1
(43) Pub. Date: Nov. 13, 2008

(54) Interactive Television User Interface

(76) Inventor: Jonathan Peter Vincent Drazin, Berks (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/158,734

(22) PCT Filed: Dec. 22, 2006
(86) PCT No.: PCT/GB06/04893

§ 371 Date: Jul. 17, 2008

(30) Foreign Application Priority Data
Dec. 22, 2005 (GB) 0526045.0

(51) Int. Cl. H04N 5/445

(52) U.S. Cl. 725/40

(57) ABSTRACT

An interactive television user interface (439) that is adapted to allow a user to access a service; receive personalised data inputs for a service for a designated user; store the personalised data for that service and present the stored data to the designated user the next time the service is accessed. The personalised data may include; for example, weather information for a user selected geographic area (444, 441, 442).

The present invention relates to an interactive television system that supports an improved electronic programme guide (EPG) and other service entertainment and informational features.

### BACKGROUND OF THE INVENTION

Interactive television services have been in wide scale use for some years. These services are mostly implemented within digital television apparatus whose computation, memory and graphics resources have been augmented to allow software applications to be downloaded from a broadcaster or an internet service operator and executed locally within the appliance. It is important to optimise the implementation of interactive service menus and payment systems within these appliances because users frequently have limited time and patience to invest in the use of these services. For example, a delay between selecting a service from a menu display and its availability to use (e.g. due to downloading of the service's content from a broadcast carousel) is off putting for most users, with the result that many users may choose not to access a service. Another problem is the method of implementation of service menus on screen, where a need for a large number of key presses causes user resistance. Increasingly, a broad range of interactive services is being offered that may require implementation of parental control features to limit user access. Examples include services such as betting or dating, where it may be desirable to block under age use. Frequently in such circumstances, it is desirable also to blank the service's name from a service menu.

Many of the aspects of a user interface and the configuration of the services accessed via it are personal to the interests of a particular user. Users frequently prefer to return to a service and find it in the same state as when they last exited it. For example, a user may configure a weather service to view a weather forecast and prefer to return to the same city selection each time. As another example, a user may prefer to return to the same level of an electronic game as was played previously. Moreover, multiple users often share the same television apparatus so that a current user of a particular service may not necessarily also be the previous user of the same service. Consequently, there is a need for a system for accessing services whereby a user can identify him or herself to the apparatus and resume a session with a service in the same state as when he or she last used it. This is also an issue when parental control methods at an individual user level are applied to control access to television channels and video on demand programmes. Accordingly, there is a need for a method of user interface implementation that allows account holders to proscribe easily service accessibility by user within a household.

Easy, quick navigation within an electronic programme guide (EPG) to a programme on a desired channel or on a desired day is another popular barrier to frequent use. EPGs are frequently displayed using a grid representation where programme events are displayed as cells inset within rows according to their channel, and positioned horizontally along a time of day axis according to when they are shown. User navigation to programmes on a different day is a common frustration with such EPGs. Often two labels, “+24 hrs” and “−24 hrs”, are displayed to the television screen whose colours correspond to the respective colour “fastext” keys on the television appliance's remote control. A common difficulty with this approach is that normally only two colour keys remain for other important functions that might be assigned to them. Another difficulty is that a user has to press a key several times in order to navigate to several days ahead, and then must press another key a corresponding number of times to return to the day from which he or she started. This is inconvenient.

Selection of programmes from among a large number of channels is another common limitation of grid based EPGs. Typically with such user interfaces, a user must press keys on the remote control that denote page up and page down actions in order to navigate focus between blocks or pages of channels. Each time these keys are pressed, the EPG displays a block of channel rows contiguous with the block previously displayed. A limitation of this approach is that the desired channel is not displayed until it is reached, with the result that a user may not know in which direction, up or down, to page in order to reach it. To overcome this, a user may switch the display to a two (as opposed to one) dimensional matrix of channel cells in order to assist navigation. Often the channel rows of a grid guide are cluttered with channels in which the viewer is disinterested, resulting in visual confusion and a greater need to press keys to navigate over them. Accordingly, it is another objective of the invention to enhance the usability of two-dimensional channel matrices when used in conjunction with grid based EPGs in order to ease user navigation in both modes.

### SUMMARY OF THE INVENTION

According to one aspect of the present invention, there is provided an interactive television interface comprising means for accessing a service; means for receiving personalised data inputs for a service for a designated user; means for storing the personalised data for that service and means for presenting the stored data to the designated user the next time the service is accessed.

The personalised data may affect the service interface or screen output. The service may be a weather service and the personalised data input the geographic area of interest to the designated user. The service may be a game and the personalised data input may be operable to affect a state of the game, such as the appearance of or label associated with one or more characters.

According to another aspect of the present invention, there is provided an interactive television guide comprising means for presenting a plurality of television listings for a plurality of days, each day being mapped to a specific key on a user input device, and means for presenting television listings for a selected day in response to receipt of a signal from its mapped key.

The television listings may be presented in a grid format. The television listings may be presented in a channel-time format.

According to yet another aspect of the present invention, there is provided an interactive television guide comprising in a first mode means for presenting television program information for a plurality of channels as a function of time; in a second mode means for presenting listings of channel information and means for toggling between the two modes in response to the same user input.

The channel information may be presented in a channel-channel grid format. The channel-time information may be presented in channel time grid format.

According to yet another aspect of the present invention, there is provided an interactive television guide that includes means for presenting television information either in a channel-time program listing format or a channel-channel format; means for presenting a currently broadcast program in a portion of the screen on which the television information is displayed; means for receiving user inputs indicative of television information selections, and means for receiving a user input indicative of whether the broadcast program that is presented on screen is to be changed in response to user television information selection.

Video corresponding to a received channel may be displayed in reduced size alongside descriptive notes of programmes. As a default position, the channel displayed on screen changes to correspond to a different channel focussed by the user. The user may over-ride this and cause the displayed reduced size video to be locked to a particular channel, so that it is displayed even when the focus on the television information is moved to a different channel.

Programme notes corresponding to the presently aired programme may be displayed for a channel in focus. As another default position, the programme details presented on screen for display may be swapped with display of detail for the next programme to be aired for the channel corresponding to the cell in focus.

### BRIEF DESCRIPTION OF THE DRAWINGS

Various aspects of the invention will now be described by way of example only and with reference to the accompanying drawings, of which:

FIG. 1 is a block diagram of the overall system comprising a service operator, a broadcaster and a television receiving apparatus;

FIG. 2 is a block diagram of a television receiving apparatus that is configured to receive data from the operator via a broadcast television network;

FIG. 3 is a top view of the remote control handset used in the system of FIG. 2;

FIG. 4 is a block diagram of the functions within a digital television receiving apparatus;

FIG. 5 shows how memory is allocated by function in the television receiving apparatus of FIG. 4;

FIG. 6 shows how personalisation settings information is stored as a file system within non-volatile memory of the television receiving apparatus of FIG. 4;

FIG. 7 shows the screen of the television apparatus when it is displaying a full screen television programme;

FIG. 8 shows the screen of the television apparatus when it is displaying a service guide whereby products and services may be selected or ordered by a user;

FIG. 9 shows the screen of the television apparatus when it is displaying a product or subscription menu whereby users may order products or services;

FIG. 10 shows the screen of the television apparatus when it is displaying a request for a PIN;

FIG. 11 shows the screen of the television apparatus when it is displaying a prompt for an administrative user to add a user to the apparatus;

FIG. 12 shows the screen of the television apparatus when it is displaying a request for an administrative user to enter a new user's name;

FIG. 13 shows the screen of the television apparatus when it is displaying a prompt for an administrative user to block or unblock access of a service to a user;

FIG. 14 shows the screen of the television apparatus when it is displaying personalisation options alongside the service guide of FIG. 8;

FIG. 15 shows the screen of the television apparatus when it is displaying a cue for a user to select a personalisation of the service guide of FIG. 14;

FIG. 16 shows the screen of the television apparatus where a personalisation has been selected;

FIG. 17 shows the screen of the television apparatus when it is prompting a user to cause a service to be omitted from the service guide when it is set to said user's personalisation;

FIG. 18 shows a flow diagram showing the process steps in selecting, creating and using service settings;

FIG. 19 shows the screen of the television apparatus when it is prompting a user to select a town within a sub-region for display of a weather forecast;

FIG. 20 shows the screen of the television apparatus when it is displaying a weather forecast;

FIG. 21 shows the screen of the television apparatus when it is displaying an EPG;

FIG. 22 shows the screen of the television apparatus when it is displaying an EPG displaying listings information for 24 hours ahead;

FIG. 23 shows the screen of the television apparatus when it is displaying a two dimensional grid of channel cells;

FIG. 24 shows the screen of the television apparatus when it is displaying a two dimensional grid of channel cells where a channel cell has been marked with an icon denoting omission of its corresponding channel from a grid based EPG, and

FIG. 25 shows the screen of the television apparatus when it is displaying a two dimensional grid of channel cells where a programme note area has been toggled between display of details of the current and next programmes from the screen of FIG. 24.

### SPECIFIC DESCRIPTION OF THE DRAWINGS

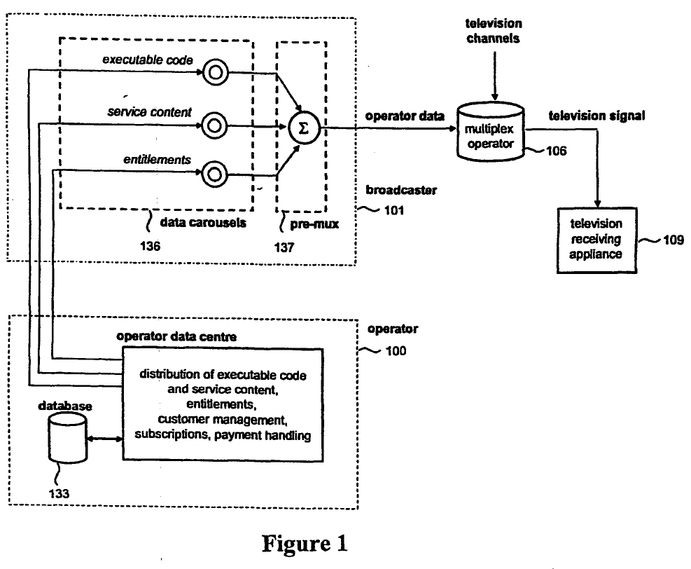

FIG. 1 shows a television system that has a plurality of user apparatus 109, an operator 100 of a broadcasting service to the apparatus 109 via a broadcaster 101 and a multiplex operator 106. The broadcaster 101 applies the respective operator data streams from operator 100 to data carousels 136 and pre-multiplexes them for transmission to a multiplex operator 106 for combination with other television and radio channels and services. Data is preferably transmitted as one or more modules using the so-called DSM-CC (Digital Storage Media Command and Control) object carousel 136. The DSM-CC carousel is a data stream transmitted by the broadcasting station alongside television audio-video service data, where each module comprises executable code and/or data components of one or more data packets that may be downloaded by television receiving apparatus.

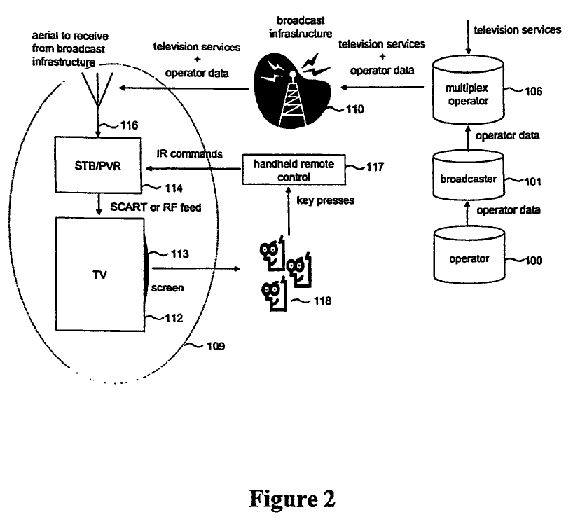

FIG. 2 shows how data streams are broadcast via an appropriate broadcast infrastructure 110 using the DVB (Digital Video Broadcasting) family of public satellite (DVB-S), and/or cable (DVB-C) and/or terrestrial (DVB-T) broadcast formats to television apparatus 109 where a manual means (not shown), such as a telephone call, composure of a mobile telephone SMS text or a spoken request may be employed to communicate information such as service subscription requests back to operator 100. Alternatively, in another embodiment of the invention, the apparatus may be connected to the operator bi-directionally across the internet (not shown in FIG. 2). The apparatus may comprise a set-top-box (STB) or personal video recorder (PVR) containing a hard disk drive for recording and playback of television programmes 114 that receives television services, including the data streams from the service operator 100, via an aerial, satellite dish or cable socket 116 and connects to a television 112 for display purposes via a screen 113 to one or a plurality of television users 118.

Apparatus 109 may have several embodiments whereby the functionalities of the STB or the PVR 114 may be integrated, or partially integrated, with the television 112 and/or display screen 113. In another embodiment the functionality of the STB or the PVR 114 is performed by a personal computer (PC) and the television's display screen 113 function is performed by a display monitor. In another embodiment, the aerial 116, STB 114, television 112, remote control 117 and screen 113 functionalities are integrated into a single handheld device such as a cordless or mobile phone, PC notebook, media player or video jukebox, palmtop computer or a personal digital assistant (PDA).

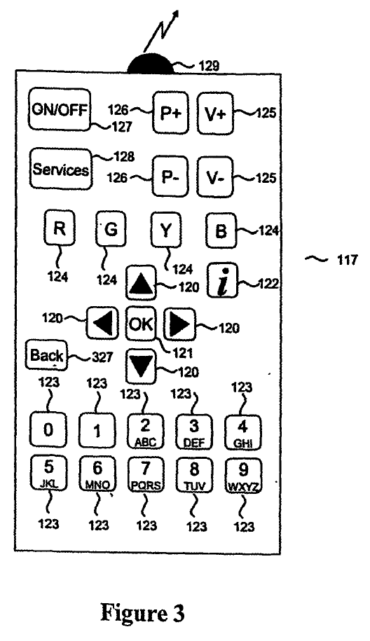

A handheld remote control 117 is provided for controlling the television apparatus 109. An example of a suitable remote control handset 117 is shown in FIG. 3. Remote control 117 sends commands to apparatus 109 preferably by wireless means. In the preferred embodiment, the handheld control 117 uses an infrared transmitter 129 to send commands to apparatus 109 that correspond to keys as they are pressed by the user, where such keys include: apparatus power ON/OFF toggle 127, volume up/down 125, channel up/down 126, red/green/yellow/blue fasttext keys 124, up/down/left/right cursor keys 120, OK/select key 121, 0-9 numeric keys 123 labelled with multiple tap alphabetic characters, a “Back” key 327 for reversing out of a user interface selection and a “Service” key 128 for causing the apparatus's service guide options 400 to be displayed as later described in this invention. Alternative embodiments for handheld control 117 may include any apparatus where keys are appropriately labelled to correspond to that of a television control apparatus, such as may be achieved using a mobile or cordless telephone, a standard “QWERTY” keyboard, a personal digital assistant (PDA), or a touch sensitive, handheld display where portions of the display are marked with labels corresponding to television control commands.

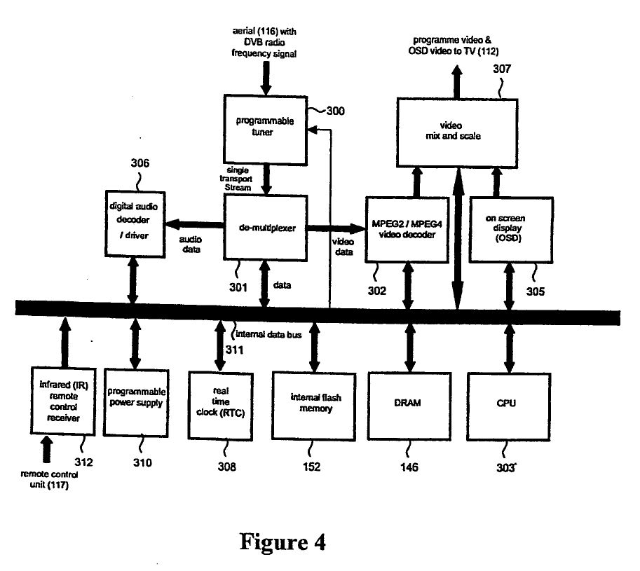

FIG. 4 shows the internal functional elements of a typical digital STB 114 designed to receive and decode DVB television transmissions. Many of the functional elements may be combined on a single large-scale integration (LSI) silicon component such as STMicroelectronics' STi5100 chipset or in the case of a digital television receiver within the television chassis. The STB of FIG. 4 has a CPU 303 coupled to volatile DRAM 146 and internal, non-volatile flash or hard disk drive based memory 152 that are integral to and not removable from the apparatus. Communication between the CPU and the other blocks is via one or more internal data buses 311. The CPU receives user commands from remote control 117 via an infrared receiver 312. When the STB is in standby, a real time clock (RTC) or countdown timer 308 controls when portions of the STB are to be powered up. In the preferred embodiment, when the STB is in standby mode between downloads, the CPU and memory operate in a low power mode with all other blocks except an RTC 308, IR receiver 312 and programmable power supply 310 powered off completely. The power supply is controlled by the CPU to apply and remove power to/from one or more of the other blocks depending on whether the STB is required to enter an active, standby or download state. The STB may have personal video recording (PVR) features and contain some form of bulk storage interface connected to a hard drive for storage of video and/or clips. This would typically be an ATAPI or SCSI hard disk interface, but any popular bulk data storage interface standard may be implemented.

The STB contains a programmable tuner 300, which is connected to receive DVB-T broadcasts via an aerial 116. Additionally or alternatively, the tuner may receive cable and satellite transmissions. By means of the internal data bus, flash based loader firmware programs tuner 300 and de-multiplexer 301 to receive and decode MPEG2 transport stream signals present at aerial 116, including the streams (channel) carrying the service operator's 100 transmissions. The tuned transport stream is applied to a de-multiplexer 301, where elementary audio, video and data streams are extracted. Video data streams are applied to the MPEG-2 and/or MPEG-4 video decoder 302. The output of this decoder is then combined with the on screen display OSD 305 to provide the video signal to the television 112. The OSD is responsible for displaying all video and graphical outputs to screen 113 of the applications. The video mix and scale function are capable of scaling the decoder video in order to present a reduced size live video display anywhere on television screen 113.

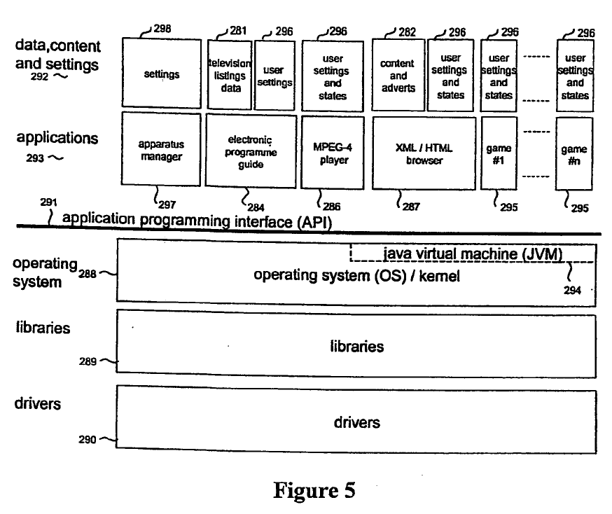

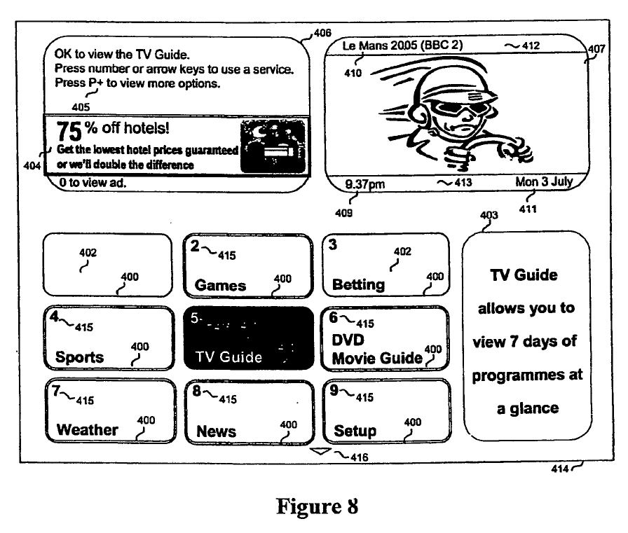

FIG. 5 shows the structure of programme application software, data, service content and settings stored for the preferred embodiment of television apparatus 109. A manager application 297 controls the downloading of all other applications 293. In the preferred embodiment, data objects are loaded periodically by the manager application over a broadcast infrastructure 110 into volatile memory 146 arranged as a file system. Each object is broadcast with a numeric identifier. The manager application looks up within settings data 298 stored in non-volatile memory 152 to determine which objects are to be downloaded. Once said objects are downloaded, the managing application authenticates and decodes them to construct a complete file system in volatile memory 146 of applications 293 and data content and settings 292 necessary for the apparatus's operation. The applications 293 include an EPG 284, which is launched by the user from a “TV Guide” option within a service guide user interface (see FIG. 8 later). Other applications include an extended mark-up language (XML) browser 287 employed to display marked up content 282 such as from the “TV magazine”, “News” and “Weather” service guide options and an audio video decoder 286 is employed to playback television programmes, movies and clips. Additional applications include games 295 which are launched from a menu reached via a “Games” option on the service guide, and an MPEG-4 player 286 to allow MPEG-4 and other audio-video formats to be played.

Each application may have associated settings data 292 that describe a particular user's progress or status in use of the application and/or a particular user's preferences. For example, settings data may record the last screen that a viewer visited in an on-screen TV Magazine together with a “bread crumb” trail of previous screens visited. In another example, settings data may contain the preferred channel identities and order that a particular user may prefer to see on an EPG. In a further example, settings data 296 may include the last level and score reached by a particular user after playing a particular game application 295.

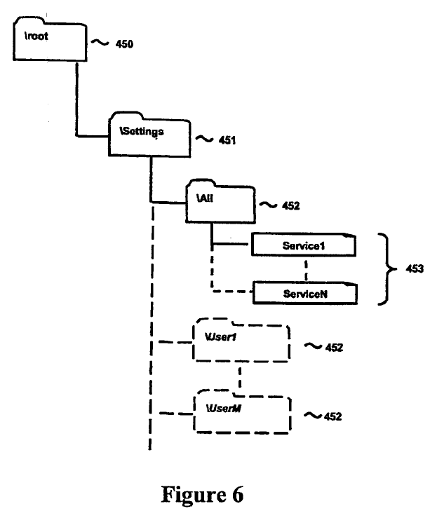

The managing application 297 and other applications store settings in non-volatile memory 152 arranged as a filing system as shown in FIG. 6. The managing application creates a directory 451 to store settings data directly beneath the root directory 450 for the whole of the apparatus' file system, and then creates a subdirectory 452 within the settings directory 451 for the case when no personalisation is set (“. . . \All”) plus a subdirectory 452 for each personalisation registered by the Administration user (see later). For each service available to the user, a data file or directory 453 containing the user's settings and preferences may be created. The applications 293 all communicate with an operating system 288 and code libraries 289, graphics and data communications and hardware drivers 290 and other components via a common application programming interface (API) 291. Each application 293 may have associated with it data, content and settings 292 which it may process. Preferably, all applications are adapted to run over Java, or some other form of virtual machine 294.

### Service Guide

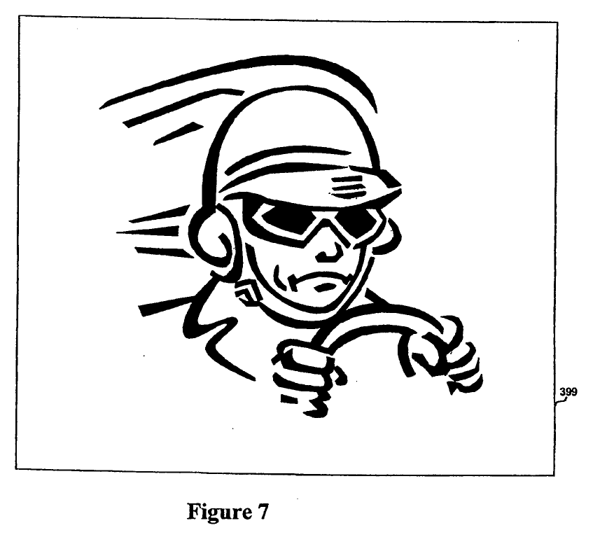

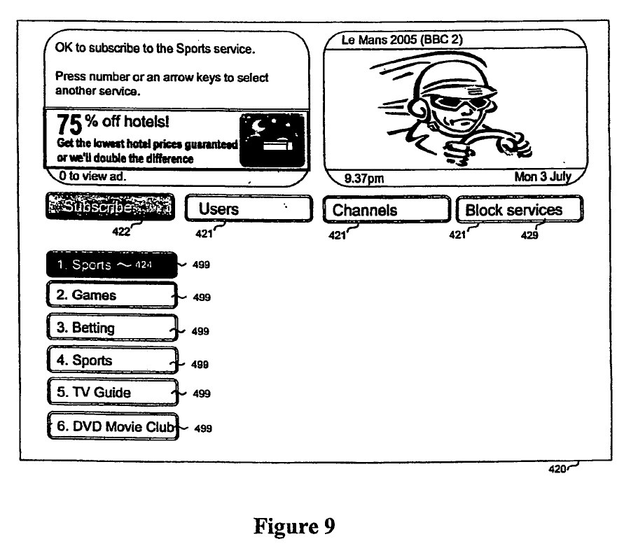

FIG. 7 shows the display from the television receiving apparatus when the user is watching full screen television 399. A user may cause the apparatus to display a service guide 414, shown in FIG. 8, by pressing the Services key 128 on the remote handset 117. The service guide displays a 3 by 3 grid of cells 400. One of the cells 401, the so called “cell in focus”, is highlighted differently compared to the other cells to denote that the service it corresponds to will be invoked when the user presses the OK key 121 on the remote handset. Each cell may correspond to a service. Where a cell corresponds to a service, it is labelled with the service's name and/or graphic logo and a number 415 and displayed differently, compared to the other cells 402, preferably as a raised 3-dimensional button or by being animated. A user may move the focus, and hence move also the differential highlighting 401, to another cell by pressing arrow key 120 corresponding to the desired direction. For example, pressing the left arrow 120 when the focus is on “TV Guide” moves the focus to “Sports”, as shown in FIG. 9. Upon entry from full screen television 399, the central cell 401 is placed in focus. This has the advantage that any other cell can be focussed with not more than 2 arrow key presses.

Another area 403 displays descriptive information of the service currently in focus, so that a user may focus from cell to cell and learn about each service by reading the information displayed in the area 403. As the user moves the focus from cell to cell, the descriptive information is updated with information that is pertinent to the latest cell in focus. A page scroll marker 416 is displayed when service options are available off screen in the direction indicated by the marker, in which case the user may select another 3 by 3 group of cell options by pressing a page scroll button 126 on the remote control 117. Each cell 400 is associated with a service and a command line (comprising a call for the operating system to launch a specified application 293 with specified arguments when it is selected). The service guide features an information panel 406. The upper section of the panel displays help information 405 according to the cell that is in focus 401. The service guide features also a picture in graphic 407 that corresponds to the video previously displayed in full screen 399 when the service guide was invoked. Helpful television related viewing information is displayed in the top border 412 above the picture in graphic that includes the title of the currently viewed programme event and the name of its broadcast channel in parentheses 410. Additionally, time 409 and date 411 are displayed in the graphic's bottom border 413.

### Personalisation

Several persons 118 may be using the same service guide on a shared STB or television in a typical home. Some services, and their corresponding cells 400, may not be appropriate to be seen by all persons. For example, it may be preferable that a betting service is not seen or used by children. Additionally, if many services are available, a user may want to limit display to only those cells 400 that correspond to the services he or she is likely to use. It would be desirable, therefore, to display on the service guide only those cells 400 that correspond to services that a person has been permitted to access. A process whereby a person is permitted to access services is now described.

At least one user 118 in a household, the administration user, has knowledge of a four digit administration personal identification number that was supplied to the purchaser of the TV apparatus 109 preferably at time of retail. The administration user may register other permitted users of the apparatus 109 by selecting the cell 400 on the service guide 414 that corresponds to the “Setup” function of FIG. 8, causing the apparatus 109 to redraw the display 113 to as shown in FIG. 9 to show a menu 420 of labelled cells 421 and 422. Preferably, each cell is marked with a colour that associates it uniquely within a corresponding “fasttext” colour hotkey 124 on the TV remote control 117. A number of setup options are displayed on the fasttext cell labels 421 and 422. One of the cells 422 is selected by default, and is highlighted differently from the other cells 421. A column of cells 499 is displayed beneath the cells 421 and 422 to show user sub-options that are pertinent to the option of highlighted cell 422. As was previously described for a cell in focus 401 on the service guide, one of the cells is displayed differently 424 to the other cells 499 to show that it is in focus. A user may press one of the arrow keys 120 to cause the apparatus to redisplay the focus as moved to another cell 499 according to the direction of the key 120 pressed.

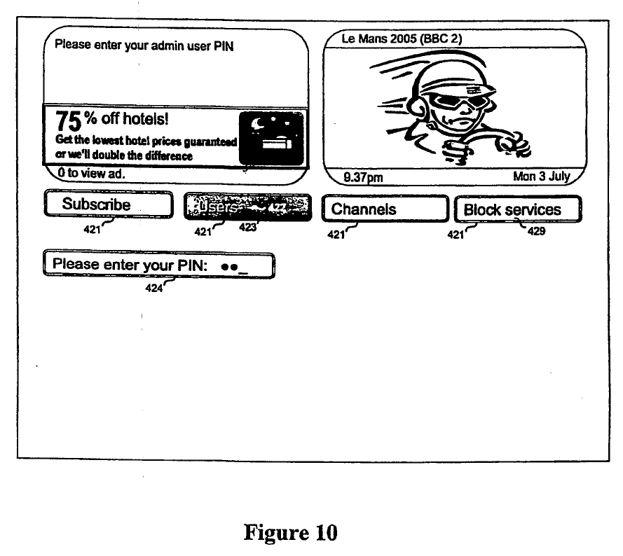

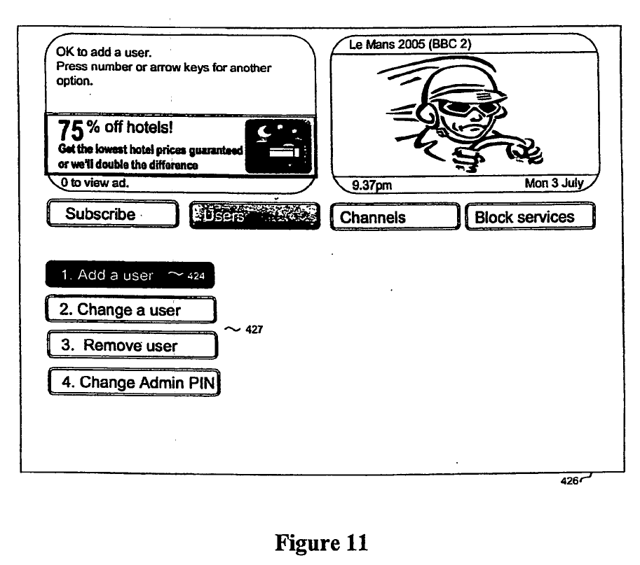

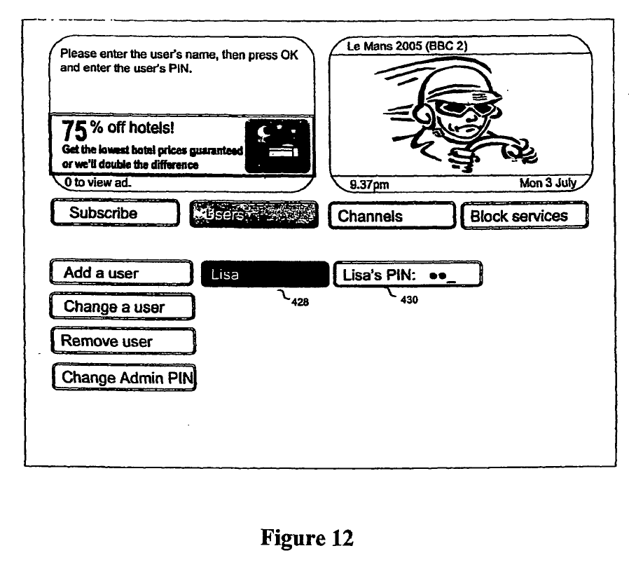

FIG. 10 shows how the administration user presses the fasttext key that corresponds to registration of users (“Users” in the figures) to cause its corresponding cell 423 to be highlighted differently from the other fasttext cells 421 and to display a request box 424 to prompt the administration user to key in the administration PIN into the remote control 117. Upon receipt of a valid Admin PIN, the apparatus re-draws the screen, as per 426 of FIG. 11, to display a column 427 of cells where each cell is labelled to correspond to a particular user registration process. Preferably the cell corresponding to registration of a new user is immediately in focus 424 so that the administration user can select by pressing the OK key 121 and key the user's name using the alphabetically labelled remote control number keys 123. When this is done, the apparatus displays the user's name 428 and a prompt 430 for the administration user to nominate a PIN for the user, as shown in FIG. 12.

### Blocking Services

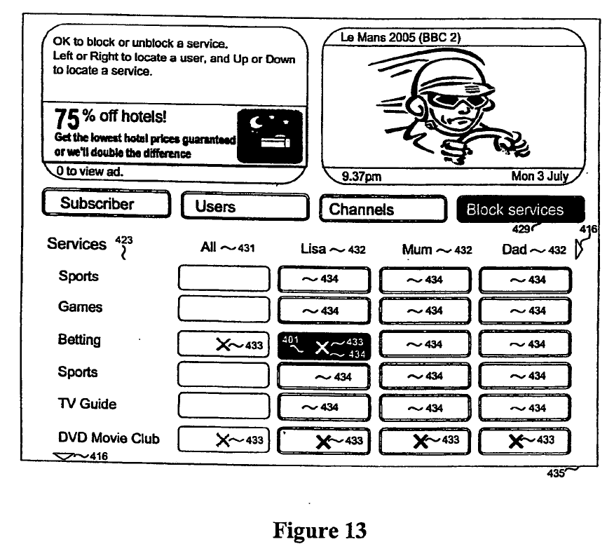

An administration user may block services from viewing by a particular user by selecting the “Setup” option in the service guide 414 and then selecting “Block services” 429 in the setup guide 420, causing a “Blocked Services” guide 435 to appear as shown in FIG. 13. The Blocked Services guide displays a leftmost vertical column of labels 423, where each label occupies a horizontal row and corresponds to a particular service that may be displayed on the service guide and selected by a user. Immediately to the right, adjacent to the service labels column 423 another column 431 of cells is displayed that corresponds to “all” users, where the apparatus is for shared use. A further column 432 of cells is displayed to the right of the “all” users column 431 for each user that has been registered with the apparatus as previously described. The head of each column, 432, is labelled with a user's name. The administration user may navigate a focus 401 across those cells that intersect the service rows and the user columns 434 and press OK to toggle whether access to a given service may be blocked or unblocked for a user. A blocked cell 433 is marked differently to an unblocked cell, preferably with an “X” or a no entry sign. Preferably all cells 434 are unblocked by default. Wherever a service has been blocked, a block icon 433 is also displayed in the “all column” 431 to show what services are accessible to a user or guest who does not identify him or herself to the apparatus.

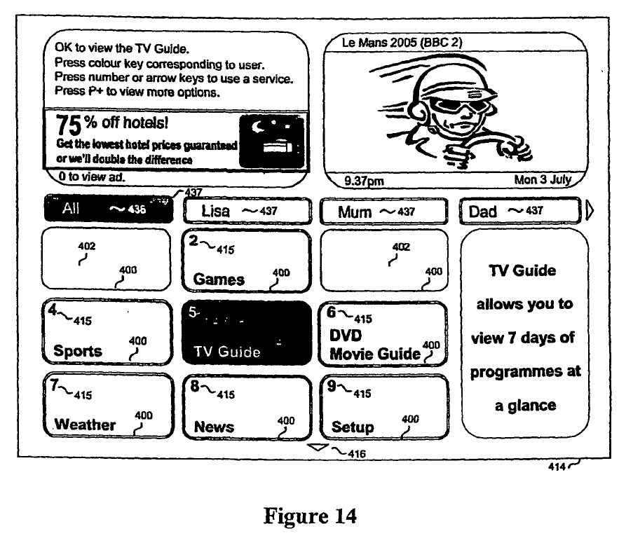

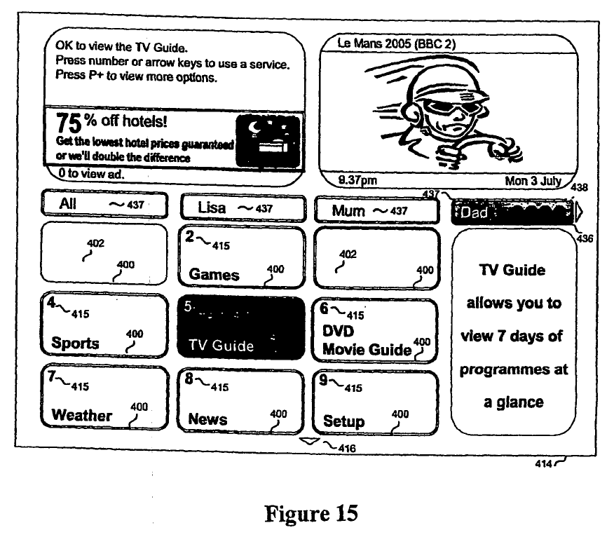

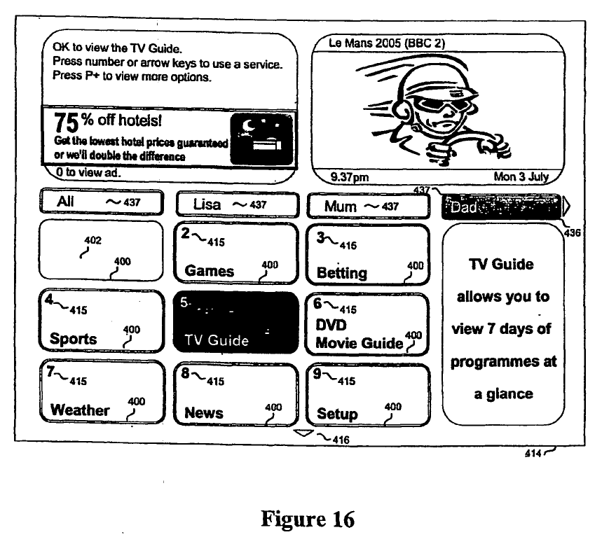

The apparatus displays personalisation cells, 436 and 437 as shown in FIG. 14, once the administration user has registered a user. Each of said cells may be uniquely labelled with the name of a registered user with the leftmost cell 436 labelled “All”. By default, unless selected otherwise by a user, the “All” cell is highlighted differently to the other cells 437 to show that it is selected by default. Where the “All” cell 436 is selected, only the label and contents cells corresponding to those service(s), which have not been blocked by the Administration user for access by any registered user are displayed on the service guide 414. A user may communicate his or her identity to the apparatus by pressing the fasttext key 124 whose colour corresponds to his or her name label within the personalisation cells 437. Where a user has been blocked by the Administration user from accessing a service he is required to enter his PIN if he is registered by the Administration user to access particular services, which other users cannot access. For example in the case shown in FIG. 13, “Lisa” is not required to enter a PIN, whereas both “Mum” and “Dad” are. During PIN entry a non-numeric symbol corresponding to each PIN digit entered 438 is displayed by the apparatus as inset within the user's name 436, as shown in FIG. 15. Assuming entry of a valid PIN, the apparatus redraws the display to include all the service options that the user is permitted to use, as shown in FIG. 16, where the “Betting” service is now available for selection from the service menu by “Dad”.

### Service Guide Customisation

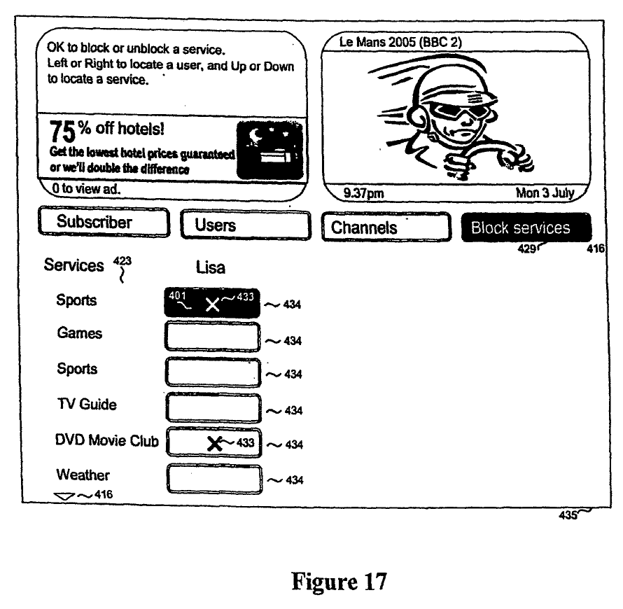

Registered users who are not administration users may cause the apparatus not to display services on the service guide in which they are disinterested by invoking the “Block services” option 429 (shown in FIG. 10) causing the apparatus to display screen 435, as shown by FIG. 17. The apparatus displays only those services 423 that the user is permitted by the Administration user to see, and allows the user to toggle services as blocked 433 or unblocked by focussing upon 401 and selecting the appropriate cell 434. Where a user marks a cell 434 as blocked 433 its corresponding service is not later displayed in the service guide when said user's personalisation is invoked.

### Service States

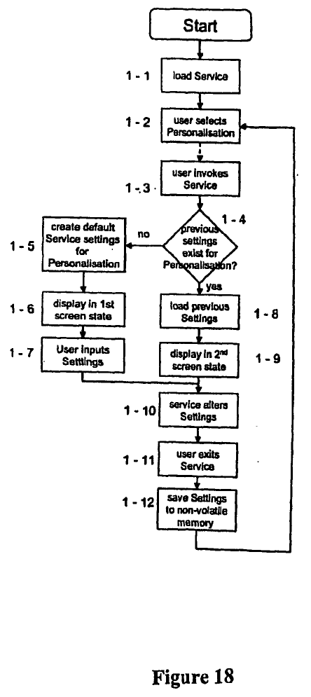

The system in which the invention is embodied is adapted to offer continuity between use of each service for each registered user. This is achieved by executing services using the settings 298 that were current when the service was last exited in the same personalisation. The process is shown in FIG. 18 and is described in detail below. In the preferred embodiment the application 293, data and default settings 298 for a new Service are loaded into memory within the apparatus (1-1). Prior to selecting the Service, user invokes the service guide 414 by pressing the “Services” key 128 on the remote control. The user selects his personalisation by selecting the appropriately labelled cell 437, whereupon the managing application renders the selected cell differently from the other personalisation cells to show that personalisation 436 is set (1-2) and stores the identity of the selected personalisation in non-volatile memory 152. Before invoking a service (1-3) the user may back out of the service guide 414 and return to full screen viewing 399.

At some point, the user selects a service from within the service guide 414 (1-3). The application associated with the selected service looks up the current personalisation stored in 298 and, referring to FIG. 6, determines whether the service's settings 453 exist in a subdirectory 452 that corresponds to the current personalisation (1-4). If the settings do not exist, then default settings are created (1-5) and the application displays a first screen configuration whereby the user can amend the settings according to his preference (1-6, 1-7). For example, a service may comprise a “virtual pet” game where a user cares and looks after a virtual animal over a period of days or weeks. In the example, the user may initialise the game's preferences by naming his pet as, say, “Fido” and choosing its colour as, say, brown. If the settings exist (1-4), the application loads the settings from non-volatile memory 152 (1-8) and displays a second screen configuration that reflects the existence and values of the settings data (1-9). Using the previous example, the game application would load the pet's name and appearance, plus details of the pet's condition such as its weight, hunger and mood. During use, the application may input further settings from the user and preferences 453 (1-10) and re-save them in his personal subdirectory 452 upon the user exiting the service (1-11, 1-12).

### Weather

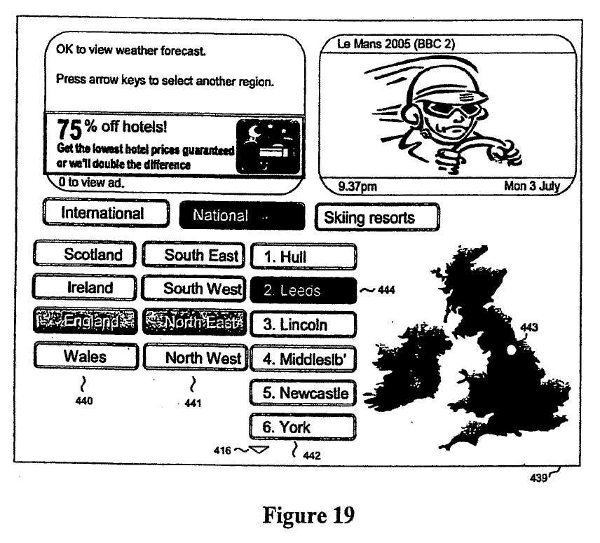

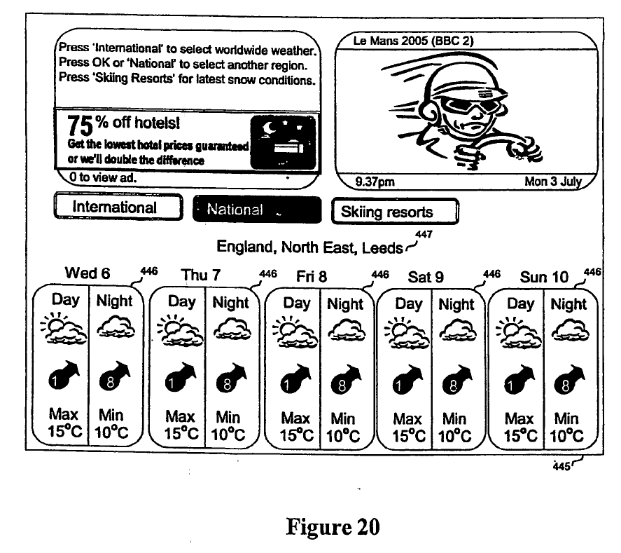

The following is a further example of a weather application, and is one of several possible services where the usefulness to television viewers of personalisation coupled with recovery of a user's previous settings may be demonstrated. As previously described, a user identifies himself to the apparatus from within the service guide 414 by selecting the colour fasttext key 124 that corresponds to his name 437. A user selects the weather application 293 (by selecting the relevant cell 400 within the service guide), the application starts and determines whether a settings file 453 for the weather service exists in the subdirectory 452 that corresponds to the user's personalisation. If the settings file does not exist (i.e. because it is the first time that the user has used the weather service), the weather application displays to the screen an introductory screen 439 that invites the user to input his desired settings. This is shown in FIG. 19 where the user may navigate focus across a hierarchy of multiple pull down menus 440 and 441 in order to select a weather forecast for a desired town or sub-region 444. The user selects the OK key, causing the weather application to redraw the screen with a forecast 445 by looking up pre-loaded weather information from content 292 for the town in focus 444 as shown in FIG. 20. Simultaneously, the application saves settings information 453 containing the identity of the user's selected sub-region or town 444 to the user's subdirectory 452. A benefit of the invention is that, on second and subsequent uses of the applications, the user does not have to return to the application's initial settings and to re-navigate back to the same state in which it was used last.

### Electronic Programme Guide Day Navigation

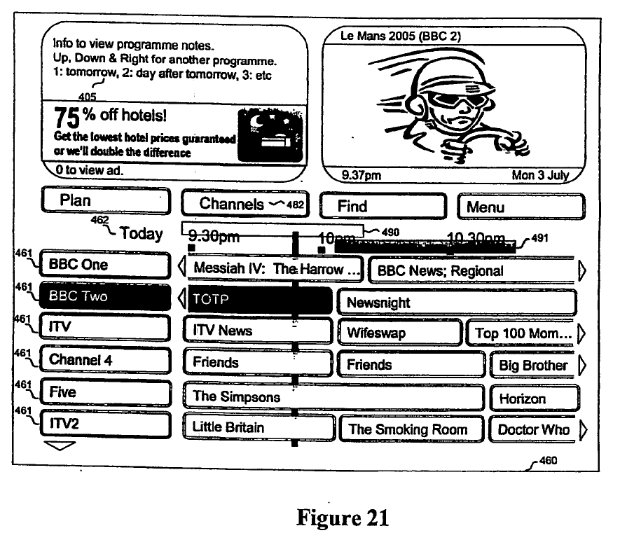

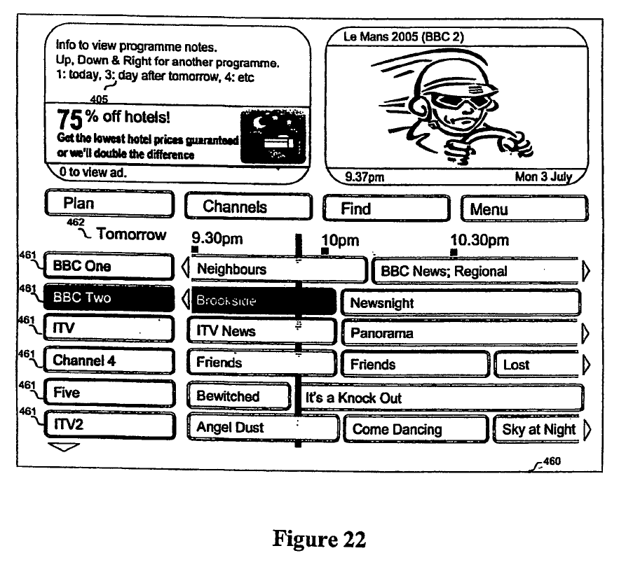

An improved user interface to assist day navigation within an EPG is now described. As shown in FIG. 21, the apparatus displays to screen a grid EPG format where programmes and their durations are plotted in two dimensions in a first area on the screen, with time occupying the horizontal axis and discrete channel identities occupying the vertical axis as rows. A label 462 indicates for which day programmes are being displayed. A help instruction 405 is displayed to assist the user on how to navigate to another day. A plurality of keys are reserved on the remote control for navigation to particular days of programmes that may be displayed by the EPG. Each reserved key maps to a particular day ahead from the current day. In the preferred embodiment, the keys ‘1’ to ‘9’ 123 are each mapped to a particular day ahead, where the key ‘1’ corresponds to today, the key ‘2’ corresponds to tomorrow, the key ‘3’ corresponds to the day after tomorrow and so forth. Preferably the keys are labelled ‘Today’, ‘Tomorrow’, ‘Day+2’, ‘Day+3’ etc. A user presses one of the reserved keys, causing the remote control 117 to send an infrared command identifying the key pressed to the apparatus 109, where the command is received by the EPG application 284. The EPG application redraws the screen to show programmes on the day that corresponds to the identity of the key pressed. Simultaneously, the EPG application updates the day label 462 to show the day's identity. For example, in the embodiment described, the EPG redraws the first area of the screen to show programmes for the second day (i.e. “tomorrow”), updates the day label 462 to “Tomorrow” and updates the help instructions 405, as shown in FIG. 22.

### Electronic Programme Guide Channel Navigation

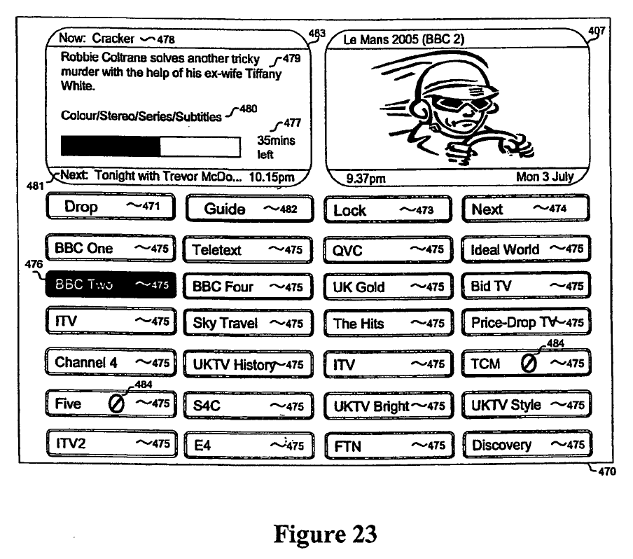

Another improvement of this invention is to a method of user navigation between channels across both a channel-time based EPG and a channel grid based EPG. This method is described below. As previously described FIG. 21 shows a channel-time based EPG 460. A user switches EPG display to a channel grid representation by pressing a key 124 corresponding to a labelled (“Channels”) cell 482, causing the apparatus to redraw the screen to a channel grid representation 470 as shown in FIG. 23. This representation displays a 2-dimensional grid of cells 475, each marked with the identity of a channel, of which the cell that corresponds to the identity of the tuned channel (appearing in a picture in graphic panel 407) is placed in focus 476. For ease of navigation, cell 482 is re-labelled so that upon pressing the same key 124 a user can quickly toggle between channel-time 460 and channel-channel 470 representations by pressing the same key 124. The user may cause the EPG to exit by selecting a channel cell 475 to cause the apparatus to tune to the channel corresponding to the cell in focus 476 and display said channel in full motion video 399.

### Drop and Restore

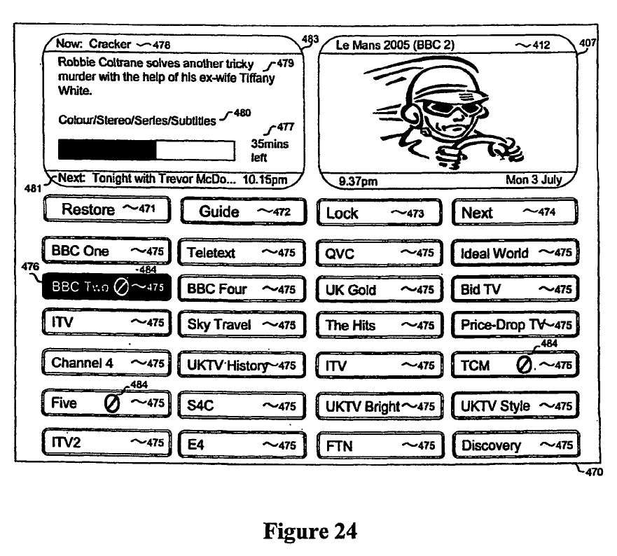

A user may press a key 124 corresponding to a cell 471 that causes the channel row 461 corresponding to the cell in focus 476 to be omitted from display on subsequent selections of the channel-time representation 460. Thereupon, the focussed cell 476 is marked with an icon 484 to denote that the channel is to be omitted. The labelling on cell 471 is redisplayed as “Restore”, as shown in FIG. 24, to show that the channel will be restored to the channel-time representation 460 (such as by labelling “Restore”) on subsequent selection if said key 124 is pressed.

### Lock and Unlock

As previously described, a user can press the arrows keys 120 to cause the apparatus to redraw the focus 476 over another cell 475. By default, the picture in graphic panel 407 displays the title, channel identity and video corresponding to the channel cell in focus and is updated by causing the channel to be tuned to the channel pertinent to the focus 476 as it is moved between channel cells 475. The user may cause the apparatus to freeze the picture in graphic panel 407, so that it is not responsive to movement of focus 476 across the channel cells 475, by pressing a key 124 that corresponds to a cell indicating a channel lock function 473. Thereupon, the picture in graphic panel 407 or border 412 is marked with a text or graphic (such as a padlock icon) to indicate that the displayed channel within panel 407 is locked, and the labelling on cell 473 is redisplayed to show that the channel locking function may be disabled (such as by labelling “Unlock”) if said key 124 is pressed.

### Now and Next

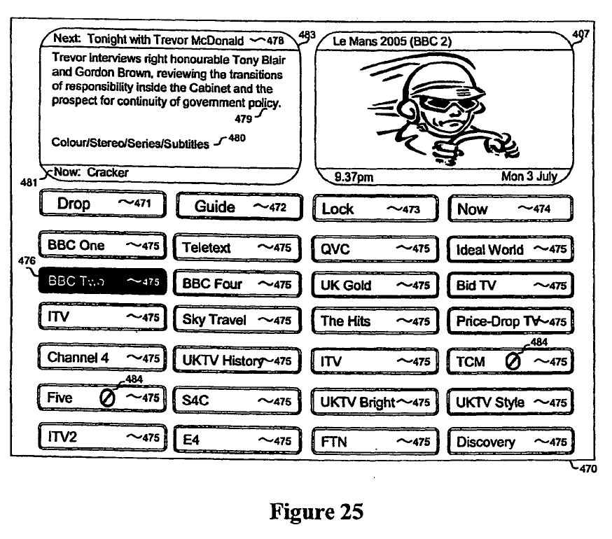

A panel 483 displays the title of the currently (“Now”) aired programme 478 on the channel in focus 476 alongside a textual and/or graphical description 479 and a listing of attributes describing said programme 480. In addition, a graphic of a fuel gauge and/or text 477 is displayed to denote the length of said programme and time remaining. The title of the following programme 481 is displayed to the bottom of panel 483. Panel 483 is always updated with information pertinent to the channel cell in focus 476 as the focus is moved between channel cells 475. A user may press a key 124 corresponding to a cell 474 that indicates a function whereby the programme description detail 479 and attributes 480 are to be given for the following (“next”) programme. Thereupon, the “now” 478 and the “next” 481 labels at the top and bottom of the panel 483 are swapped and the programme description 479 and attributes 480 are redisplayed to correspond to the “Next” programme to be aired on the channel whose cell is in focus 476. Labelling of cell 474 is redisplayed as “Now”, as shown in FIG. 25, to show that the description 479 and attributes 480 may be swapped back to describe the current programme if said key 124 is pressed.

A skilled person will appreciate that variations of the disclosed arrangements are possible. Accordingly the above description of the specific embodiment is made by way of example only and not for the purposes of limitation. It will be clear to the skilled person that minor modifications may be made without significant changes to the operation described.

1. An interactive television system/user interface comprising means for accessing a service; means for receiving personalised data inputs for a service for a designated user; means for storing the personalised data for that service and means for presenting the stored data to the designated user the next time the service is accessed.

2. A television system as claimed in claim 1 wherein the personalised data affects the service interface or screen output.

3. A television system as claimed in claim 1 wherein the service is a weather service and the personalised data input is the geographic area of interest to the designated user.

4. A television system as claimed in claim 1, wherein the service is a game and the personalised data input is operable to affect a state of the game.

5. A computer program for an interactive television system, on a data carrier or computer readable medium, the computer program having code or instructions for receiving personalised data inputs for a service for a designated user; storing the personalised data for that service and presenting the stored data to the designated user the next time the service is accessed.

6. An interactive television guide comprising means for presenting a plurality of television listings for a plurality of days, each day being mapped to a specific key on a user input device, and means for presenting television listings for a selected day in response to receipt of a signal from its mapped key.

7. An interactive television guide as claimed in claim 6 wherein the television listings are presented in a grid format.

8. An interactive television guide as claimed in claim 7 wherein the television listings are presented in a channel-time format.

9. A computer program on a data carrier or computer readable medium having code or instructions for presenting a plurality of television listings for a plurality of days, each day being mapped to a specific key on a user input device, and presenting television listings for a selected day in response to receipt of a signal from its mapped key.

10. An interactive television guide comprising in a first mode means for presenting television program information for a plurality of channels as a function of time; in a second mode means for presenting listings of channel information and means for toggling between the two modes in response to the same user input.

11. An interactive television guide as claimed in claim 10 wherein the channel information is presented in a channel-channel grid format.

12. An interactive television guide as claimed in claim 10 wherein the channel-time information is presented in channel time grid format.

13. A computer program for an interactive television system, on a data carrier or computer readable medium, the computer program having code or instructions for in a first mode presenting television program information for a plurality of channels as a function of time; in a second mode presenting listings of channel information and toggling between the two modes in response to a user input.

14. An interactive television guide that includes means for presenting television information either in an channel-time program listing format or a channel-channel format; means for presenting a currently broadcast program in a portion of the screen on which the television information is displayed; means for receiving user inputs indicative of television information selections, and means for receiving a user input indicative of whether the broadcast program that is presented on screen is to be changed in response to user television information selection.

15. An interactive television guide as claimed in claim 14 wherein as a default position, the broadcast program is changed in the event that the user selects a different channel.

16. An interactive television guide that includes means for presenting television information either in an channel-time program listing format or a channel-channel format; means for receiving user inputs indicative of television information selections, and means for receiving a user input indicative of whether the broadcast program information that is presented on screen is to be changed in response to user television information selection wherein the broadcast program that is presented on screen is toggled between display of a present broadcast programme and display of a following programme to be broadcast responsive to the user input.

17. An interactive television guide that includes means for displaying radio or television programme information; means for receiving user inputs each indicative of a respective number of days ahead relative to the current day wherein each said input corresponds to a labelled number key, means for mapping each said key to a future day relative to the current day, means for displaying simultaneously the identity of said future day alongside programme information for said future day.

18. An interactive television guide that includes means for displaying programme information according to claim 17 where the keys are labelled with each single digital number ‘1’ to ‘9’.

19. An inactive television system comprising a user interface and means for accessing a plurality of interactive television services whose content is stored simultaneously within said system; means for receiving inputs from a master user concerning whether a service may be accessed by one of a plurality of users registered with the system; means for a registered user to identify him/herself to the system; means for displaying a guide which selectively displays the availability of interactive services for selection by said registered user according to the master user's inputs.
